(19) United States
(12) Patent Application Publication
(10) Pub. No.: US 2004/0232903 A1
(43) Pub. Date: Nov. 25, 2004

(54) L-D snubber for different type PFC circuit

(75) Inventors: Jianping Ying, Taoyuan Shien (TW); Qiuhua Zhu, Taoyuan Shien (TW); Raymond Lee, Taoyuan Shien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 10/848,287

(22) Filed: May 18, 2004

(30) Foreign Application Priority Data
May 23, 2003 (TW) 092114094

(51) Int. Cl. G05F 1/40

(52) U.S. Cl. 323/286

(57) ABSTRACT

In the UPS and communication power supply system, the output voltage of the PFC circuit is relativly high. The phenomenon of reverse recovery is also relativly serious for the use of a high voltage diode. A simple L-D snubber, which is suitable for PFC circuit of every kind of power system is provided for suppressing the phenomenon of reverse recovery of the diode so as to reduce all kinds of switch loss caused by the phenomenon and improve the efficiency of power system.

### FIELD OF THE INVENTION

This invention relates to an L-D (inductor-diode) snubber, and more particularly to an L-D snubber suitable for power factor correction (PFC) circuit of every kind of power system.

### BACKGROUND OF THE INVENTION

In the uninterruptible power supply (UPS) and communication power supply system, since the output voltage of the PFC circuit is relatively high, the use of a high voltage freewheeling diode is required. Generally, the voltage of the PFC is output by the Bus+ and Bus−, and the high voltage freewheeling diode bears the entire voltage of the Bus+ and Bus−. However, in the practical application the phenomenon of reverse recovery is relatively serious for the use of a high voltage freewheeling diode. Both the theoretical analysis and the experimental results show that the loss of reverse recovery and reduplicating caused by the phenomenon of reverse recovery of the freewheeling diode are the crucial causes of the energy loss in the whole system. A better efficiency applied in one power system can be achieved by suppressing the phenomenon of reverse recovery of the freewheeling diode.

Please refer to FIG. 1, which illustrates a conventional three-level PFC circuit. The three-level PFC circuit includes an importing voltage Vᵢₙ, an input inductance L, diodes D₁˜D₂, capacitors C₊˜C₋, and a switch element SW. The high voltage freewheeling diodes bear the total voltage of the Bus+ and Bus−, so above 1,000 voltage and even above 1,200 voltage diodes are needed. Therefore, the phenomenon of reverse recovery is serious when a high voltage freewheeling diode is employed.

There are many ways to suppress the phenomenon of the reverse recovery of the freewheeling diodes in the PFC circuit. For example, many kinds of active snubber and passive lossless snubber can be employed to suppress the phenomenon of the recovery of the freewheeling diode. Generally, the structure of active snubber is too complicated to be introduced in the three-level PFC circuit.

Please refer to FIG. 2, which illustrates a boost PFC circuit having a passive lossless snubber according to the prior art. By confining the phenomenon of the reverse recovery of the freewheeling diode D and the voltage change rate of the switch power Q, the switch element loss and the noise of the electromagnetic interference are effectively suppressed in the circuit. In FIG. 2, the turn-on snubber is composed of inductor L_{S}, capacitor C_{b}, and diodes D₂, and D₃. The turn-off snubber is composed of D₁ and Cₛ. The boost PFC circuit further includes the inductor L, the capacitor C, the diode D, the Bus, and the N-terminal. Moreover, in this circuit the main switch element Q can be turned on even the voltage is zero. Further, the main switch element Q almost can be cut off at zero electrical current. Furthermore, the electric current can be converted in the freewheeling diode D at zero voltage.

Although the application efficiency of the power system can be achieved by employing the passive lossless circuit, the passive lossless circuit is not preferable for the high-cost design because of its complicated circuit structure. Besides, many additional elements must be included. It might be okay to eliminate the turn-off snubber if the purpose is mainly to suppress the phenomenon of the reverse recovery of the freewheeling diode D. However, as the turn-off snubber is eliminated, the inductor L_{S} of the snubber is recovered less effectively. In order to recover effectively, the value of the inductor L_{S} must be low so that the performance of the passive lossless circuit is somehow limited.

In order to overcome the drawbacks in the prior art, an L-D snubber for different types of PFC circuit is provided. In the particular design, the simple L-D snubber suppresses the phenomenon of reverse recovery of the freewheeling diode to reduce all kinds of switch loss and to improve the application efficiency of power system.

### SUMMARY OF THE INVENTION

It is an object of the present invention to provide an L-D (inductor-diode) snubber suitable for power factor correction (PFC) circuit of every kind of power system.

It is another object of the present invention to provide a simple L-D snubber for PFC circuit of every kind of power system so as to suppress the phenomenon of reverse recovery of the freewheeling diode to reduce all kinds of switch loss and to improve the efficiency of power system.

In accordance with one aspect of the present invention, a power factor correction (PFC) circuit with an L-D (inductor-diode) snubber includes a main switch element, and an L-D (inductor-diode) snubber which includes an inductor, and a diode electrically connected to the inductor in parallel to form the L-D snubber, wherein the L-D snubber is electrically connected to said main switch element of the PFC circuit in series.

Preferably, the PFC circuit is a boost PFC circuit.

Preferably, the PFC circuit is a three-level PFC circuit.

Preferably, the PFC circuit is a buck PFC circuit.

Preferably, the PFC circuit is a dual-boost PFC circuit.

In accordance with another aspect of the present invention, a power factor correction (PFC) circuit with an L-D (inductor-diode) snubber comprises a freewheeling diode, and an L-D (inductor-diode) snubber which includes an inductor, and a diode electrically connected to the inductor in parallel to form the L-D snubber, wherein the L-D snubber is electrically connected to the freewheeling diode of the PFC circuit in series.

Preferably, the PFC circuit is a boost PFC circuit.

Preferably, the PFC circuit is a three-level PFC circuit.

Preferably, the PFC circuit is a buck PFC circuit.

Preferably, the PFC circuit is a dual-boost PFC circuit.

In accordance with another aspect of the present invention, an L-D (inductor-diode) snubber for a power factor correction (PFC) circuit having a main switch element includes an inductor, and a diode electrically connected to the inductor in parallel to form the L-D snubber, wherein the L-D snubber is electrically connected to the main switch element of the PFC circuit in series.

In accordance with another aspect of the present invention, an L-D (inductor-diode) snubber for a power factor correction (PFC) circuit having a freewheeling diode includes an inductor, and a diode electrically connected to the inductor in parallel to form the L-D snubber, wherein the L-D snubber is electrically connected to the freewheeling diode of the PFC circuit in series.

The foregoing and other features and advantages of the present invention will be more clearly understood through the following descriptions with reference to the drawings, wherein:

### BRIEF DESCRIPTION OF THE DRAWINGS

FIG. 1 is a schematic view showing a three-level PFC circuit according to the prior art;

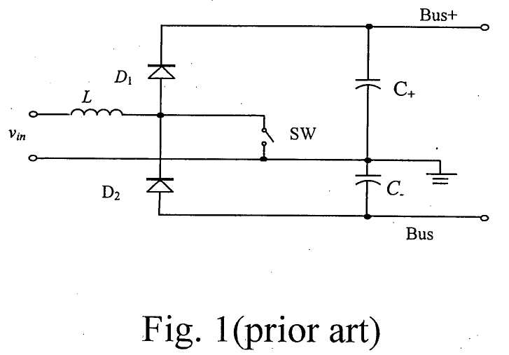

FIG. 2 is a schematic view showing a boost PFC circuit with the passive lossless circuit according to the prior art;

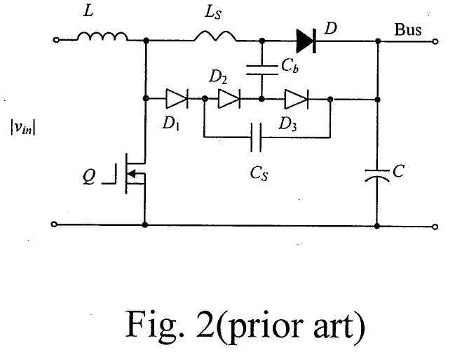

FIG. 3 is a schematic view of the boost PFC circuit showing an L-D snubber electrically connected to the main switch element in series according to a preferred embodiment of the present invention;

FIG. 4 is a schematic view of the boost PFC circuit showing an L-D snubber electrically connected to the freewheeling diode in series according to a preferred embodiment of the present invention;

FIG. 5 is a time chart of the switch according to a preferred embodiment of the present invention while the main switch element is electrically connected to an L-D snubber in series;

FIGS. 6(a) and 6(b) are schematic views showing three-level PFC circuits with an L-D snubber according to a preferred embodiment of the present invention; and

FIG. 7 is a schematic view showing a dual boost PFC circuit with an L-D snubber according to a preferred embodiment of the present invention.

### DETAILED DESCRIPTION OF THE PREFERRED EMBODIMENT

The present invention will now be described more specifically with reference to the following embodiments. The L-D (inductor-diode) snubber of the present invention includes an inductor and a diode, and it is derived from the conventional RLD (resistor-inductor-diode) snubber. The inductor confines the change rate of the reverse recovery electric current in the PFC circuit, and therefore all kinds of switch loss caused by the phenomenon of reverse recovery are reduced. The diode of the snubber provides an energy flow path for the recovery of the inductor of the snubber. By omitting the resistor of the conventional RLD snubber, the L-D snubber becomes simpler in its structure and it can be applied to all kinds of PFC circuits. According to the experiment, the PFC circuit employing the L-D snubber can also achieve a better efficiency.

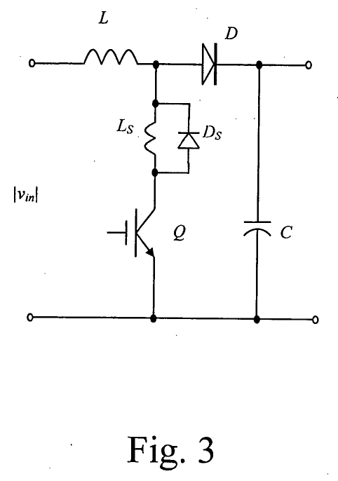

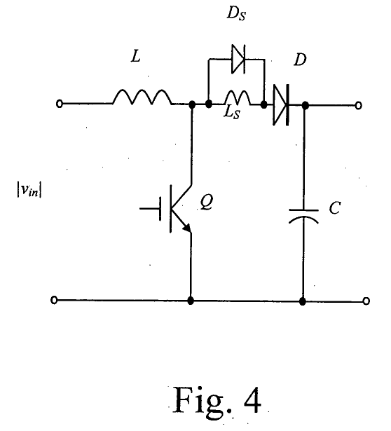

Please refer to FIG. 3, which illustrates a boost PFC circuit with an L-D snubber. In the drawing, the L-D snubber is electrically connected to the main switch element Q in series. Ls represents the inductor of the snubber and Ds represents the diode of the snubber. As L-D snubber is applied to the PFC circuit, there may exist another kind of circuit structure, i.e. an L-D snubber is electrically connected to the freewheeling diode D, as shown in FIG. 4. In the drawing, L and C are respectively represent the inductor and the capacitor of the boost PFC circuit. There are only one main switch element Q and one freewheeling diode D in the conventional boost PFC circuit. Therefore, no matter what the L-D snubber is electrically connected to, only one L-D snubber is required. However, in a three-level PFC circuit, there are two freewheeling diodes. If the L-D snubber is electrically connected to the freewheeling diodes, two L-D snubbers are required. Under the consideration of low cost and device simplification, it is apparent that the L-D snubber should be electrically connected to the main switch element Q in series.

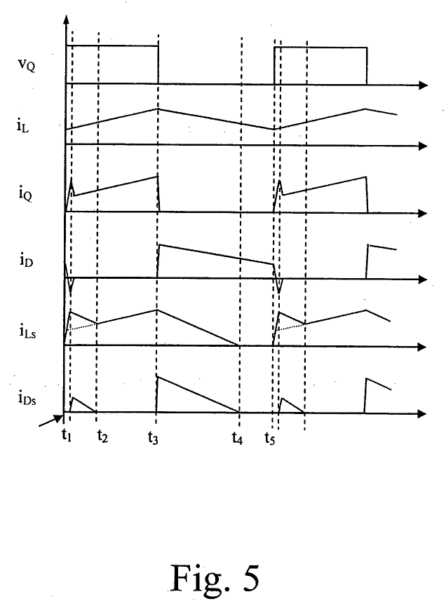

Please refer to FIG. 5, which illustrates a time chart of the switch while the main switch element Q is electrically connected to an L-D snubber in series. In the drawing, V_{Q} is the driving impulse signal of the main switch element Q; i_{L}, i_{Q}, and i_{D} respectively represent the electric current flowing through the inductor L, the main switch element Q, and the freewheeling diode D; i_{Ls} and i_{Ds} respectively represent the electric current flowing through the inductor L_{S} and the diode D_{S} of the snubber circuit. The working principle is described as follows:

At t₀, the main switch element Q starts to conduct electricity, the freewheeling diode D bears the reverse pressure and the phenomenon of reverse recovery occurs. The electrical current in the PFC inductor L and the electrical current of reverse recovery in the freewheeling diode D simultaneously flow through the main switch element Q and the L-D snubber. Since the inductor L_{S} of the snubber confines the rate of the electrical current changes of the main switch element Q and the freewheeling diode D, the repression of the reverse recovery is achieved to some extent. During this period, the inductor L_{S} bears the voltage up as positive and down as negative, and the diode D_{S} of the snubber bears the reverse pressure to maintain turn-off. Till t₁, the electrical current of reverse recovery of the freewheeling diode D reaches the maximum value.

After t₁, the reverse-recovery electrical current of the freewheeling diode D starts to diminish, which results the decreasing trend of the electrical current of the inductor L_{S} of the snubber. Therefore, the inductor L_{S} of the snubber bears the voltage up as negative and down as positive. The diode D_{S} of the snubber bears positive pressure to conduct electricity; the reverse recovery energy stored in the inductor L_{S} of the snubber is released via the loop of L_{S} and D_{S}. During this period, i_{Ls} is eaqual to i_{Ds} plus i_{Q}, (i_{LS}=i_{DS}+i_{Q}), and the electrical current i_{Ls} is basically in a linearly decreasing trend. In addition, the drop slope is V_{Ds}/L_{S}, wherein V_{Ds} is the saturated conducting drop voltage of the diode Dₛ of the snubber. Till t₂, i_{LS} is eaqual to i_{Q}, (i_{Ls}=i_{Q}), and the diode Dₛ of the snubber is turn-off at zero electrical current.

After t₂, as the electrical current flows through the power source Vᵢₙ, inductor L, inductor L_{S} of the snubber, and the main switch element Q, most energy provided by the power supply is stored in the PFC inductor L. Moreover, a small amount of energy is stored in the inductor L_{S} of the snubber. During this period, i_{L} is eaqual to i_{Q} and further eaqual to i_{Ls} (i_{L}=i_{Q}=i_{LS}).

At t₃, the main switch element Q is turn-off, and the electrical current in the PFC inductor L flows through the freewheeling diode D. At the same time, the current in the inductor L_{S} of the snubber is in a decreasing trend so that the inductor L_{S} of the snubber bears the voltage up as negative and down as positive. Moreover, the diode D_{S} of the snubber bears positive voltage and keeps conducting and further provides an energy flow path for the recovery of the inductor L_{S} of the snubber. During this period, i_{L} is eaqual to i_{D} (i_{L}=i_{D}); i_{Ls} is eaqual to i_{Ds} (i_{Ds}=i_{Ls}). In addition, the electrical current is basically in a linearly decreasing trend and the drop slope is V_{Ds}/L_{S}.

At t₄, all the energy stored in the inductor L_{S} of the snubber has been released. The diode D_{S} of the snubber is turn-off at zero electrical circuit and, i_{Ls} is eaqual to zero (i_{Ls}=i_{Ds}=0).

At t₅, a new switch cycle starts and the working principles are repeated.

From the above-mentioned principles, it is an ideal situation that the inductor L_{S} of the snubber can recover completely. However, if the parameter of the snubber is not ideal enough, i.e. the inductor value of the snubber is excessively high or the saturated drop voltage of the diode D_{S} of the snubber is excessively low, the inductor L_{S} of the snubber cannot recover during the turn-off period of the main switch element Q. In other words, the electricity in the diode D_{S} of the snubber cannot be decreased to zero. Accordingly, as a new pulse arrives and the main switch element Q conducts electricity, the diode D_{S} of the snubber bears reverse pressure to act as reverse recovery and to cause loss of the switch. Even though the electric current is not very high, the efficiency of the system is affected and thus the practical effect of the L-D snubber is confined.

When using an L-D snubber to suppress the reverse recovery of the freewheeling diode D, the inductor L_{S} of the snubber with a low value and the diode D_{S} of the snubber with a high conducting drop voltage are preferable so as to enhance the recovery of the inductor L_{S} of the snubber.

The present invention with the characteristics of device simplification and practical effects can conveniently be applied to all kinds of PFC circuits. The preferred embodiments are listed as follows:

FIG. 3 is a preferred embodiment according to the present invention showing a Boost PFC main circuit. The L-D snubber is electrically connected to the main switch element in series.

FIG. 4 is another preferred embodiment according to the present invention showing a Boost PFC main circuit. The L-D snubber is electrically connected to the freewheeling diode in series.

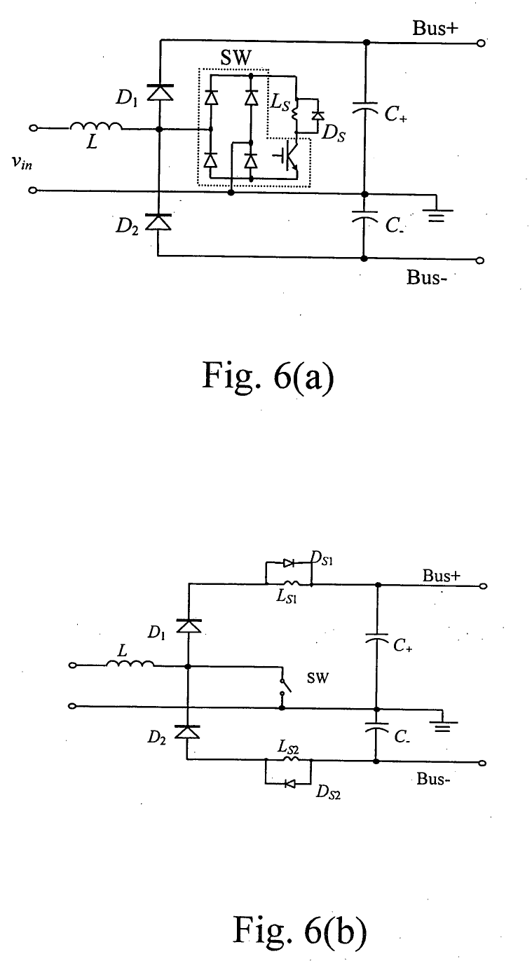

FIGS. 6(a) and 6(b) are preferred embodiments according to the present invention showing three-level PFC main circuits. The L-D snubber is electrically connected either to the main switch element (FIG. 6(a)) in series or to the freewheeling diode (FIG. 6(b)) in series. It is preferable that the L-D snubber is electrically connected to the main switch element (FIG. 6(a)) in series, because it only needs one L-D snubber.

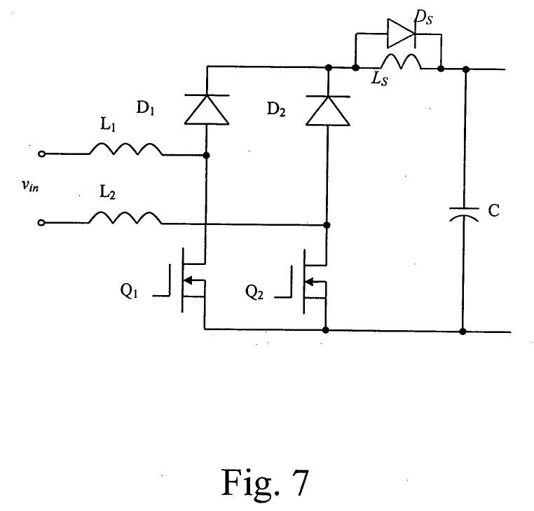

Being suitable for a dual Boost PFC circuit, the L-D snubber is electrically connected either to the main switch element in series or to the freewheeling diode in series. It is preferred that the L-D snubber is electrically connected to the output unit in series, as shown in FIG. 7, because it only needs one L-D snubber.

Being suitable for a Buck PFC circuit, the L-D snubber is electrically connected either to the main switch element in series or to the freewheeling diode in series.

Moreover, the L-D snubber is also suitable for all kinds of Boost, Buck, and DC-DC (direct current) converters. The L-D snubber is electrically connected either to the main switch element in series or to the freewheeling diode in series.

In view of the aforesaid description, the L-D snubber provided in the present invention can be applied to all kinds of PFC circuits. The inductor of the snubber confines the changing rate of the reverse recovery electric current, and thus reduces all kinds of switch loss caused by the phenomenon of reverse recovery. The diode of the snubber provides an energy flow path for the recovery of the inductor of the snubber. The present invention with the characteristic of device simplification is suitable for all kinds of PFC circuit. According to the experiment result, a better efficiency of the PFC circuit is also achieved. Thus, the present invention can effectively overcome the defects in the prior arts. Consequently, the present invention conforms to the demand of the industry and has industrial utility.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A power factor correction (PFC) circuit with an L-D (inductor-diode) snubber, comprising:
a main switch element; and
an L-D (inductor-diode) snubber, comprising:
an inductor; and
a diode electrically connected to said inductor in parallel to form said L-D snubber, wherein said L-D snubber is electrically connected to said main switch element of said PFC circuit in series.

2. The power factor correction circuit according to claim 1, wherein said PFC circuit is a boost PFC circuit.

3. The power factor correction circuit according to claim 1, wherein said PFC circuit is a three-level PFC circuit.

4. The power factor correction circuit according to claim 1, wherein said PFC circuit is a buck PFC circuit.

5. The power factor correction circuit according to claim 1, wherein said PFC circuit is a dual-boost PFC circuit.

6. A power factor correction (PFC) circuit with an L-D (inductor-diode) snubber, comprising:
a freewheeling diode; and
an L-D (inductor-diode) snubber, comprising:
an inductor; and
a diode electrically connected to said inductor in parallel to form said L-D snubber, wherein said L-D snubber is electrically connected to said freewheeling diode of said PFC circuit in series.

7. The power factor correction circuit according to claim 6, wherein said PFC circuit is a boost PFC circuit.

8. The power factor correction circuit according to claim 6, wherein said PFC circuit is a three-level PFC circuit.

9. The power factor correction circuit according to claim 6, wherein said PFC circuit is a buck PFC circuit.

10. The power factor correction circuit according to claim 6, wherein said PFC circuit is a dual-boost PFC circuit.

11. An L-D (inductor-diode) snubber for a power factor correction (PFC) circuit having a main switch element, comprising:
an inductor; and
a diode electrically connected to said inductor in parallel to form said L-D snubber, wherein said L-D snubber is electrically connected to said main switch element of said PFC circuit in series.

12. An L-D (inductor-diode) snubber for a power factor correction (PFC) circuit having a freewheeling diode, comprising:
an inductor; and
a diode electrically connected to said inductor in parallel to form said L-D snubber, wherein said L-D snubber is electrically connected to said freewheeling diode of said PFC circuit in series.
